(19) United States
(12) Patent Application Publication
(10) Pub. No.: US 2010/0319596 A1
(43) Pub. Date: Dec. 23, 2010

(54) METER PRE-COOLER FOR AMMONIA APPLICATION SYSTEM

(76) Inventor: David P. Ward, Dallas, TX (US)

Correspondence Address: Daniel V. Thompson;The Law Offices Of Daniel V. Thompson P.C., 9304 Forest Lane,, Suite N253, Dallas, TX, 75243, US

(21) Appl. No.: 12/487,967

(22) Filed: Jun. 19, 2009

(51) Int. Cl. A01C 23/00

(52) U.S. Cl. 111/119; 111/123

(57) ABSTRACT

An ammonia distribution system has an ammonia meter, and a pre-cooler heat exchanger with a reservoir located upstream of the meter and a cooling tube downstream of the meter.

### BACKGROUND OF THE INVENTION

The present invention relates in general to ammonia fertilizer application systems for agricultural use. More specifically, but without restriction to the particular use which is shown and described, this invention relates to an ammonia application system having a pre-cooler for a manual ammonia meter.

The typical ammonia application system consists of a nurse tank trailed behind a tool bar which is attached to a tractor. Application rate is controlled by a manually-adjustable mechanical meter. While electronically-controlled systems are more advanced and also commonly used, many farmers still use systems having older manual meters.

The nurse tank is a trailer-mounted pressure vessel which contains the ammonia in its liquid state. The liquid withdrawal valve is mounted at the top of the tank and has a dip tube which extends to the bottom of the tank. The ammonia flows through the meter, then to one or more dividing manifolds, and finally through suitable hoses to the applicator knives which inject the ammonia into the soil.

As the liquid ammonia enters the dip tube located at the bottom of the tank, its thermodynamic conditions begin to change. The ammonia begins to expand. This results in the formation of ammonia vapor within the system which must be removed by a heat exchanger unit prior to metering in order to assure a properly-measured quantity of ammonia to the applicator knives and into the soil. One solution currently available are the Superflow A-SF-3000 and Equalizer A-EQ-2000 heat exchangers by Continental NH3 of Dallas, Tex. The Superflow and Equalizer operate under the same principle, cooling the ammonia prior to the meter using a small amount of bypass vapor taken from the main flow line after metering. About 2% of the material is bled off through the heat exchanger. After exiting the heat exchanger, the bleed off material is directed into the ground via an extra line. The extra line can be directed to a soil knife or through the manifold to all the knives.

This prior art system works fairly well, but is relatively complex and intended for more complex electronically-controlled systems rather than simple manually controlled systems. Careful attention must be paid to the vapor bypass rate, which is controlled by selecting interchangeable orificed hose barbs. An additional plumbing system to the knives must be provided to handle the vapor that is bypassed and used for cooling. The complex prior art vapor bypass heat exchanger system does not work well with manual meter systems.

It would be a distinct advantage to have a simple ammonia heat exchanger adapted for use in simpler manual meter systems.

### SUMMARY OF THE INVENTION

An ammonia distribution system has a pre-cooler heat exchanger having a reservoir to receive a mixed stream of ammonia liquid and vapor from the source of ammonia and a cooling tube located within the reservoir to receive the entire flow of liquid ammonia from the meter and cool the contents of the reservoir prior to the meter.

### BRIEF DESCRIPTION OF THE DRAWINGS

A more complete understanding of the invention and its advantages will be apparent from the Detailed Description taken in conjunction with the accompanying Drawings, in which:

FIG. 1 is a plan view of the ammonia application system of the present invention;

FIG. 2 is an enlarged portion of FIG. 1;

FIG. 3 is a perspective view of the pre-cooler used in the invention;

FIG. 4 is a partially broken away perspective view of the pre-cooler of FIG. 3.

### DETAILED DESCRIPTION

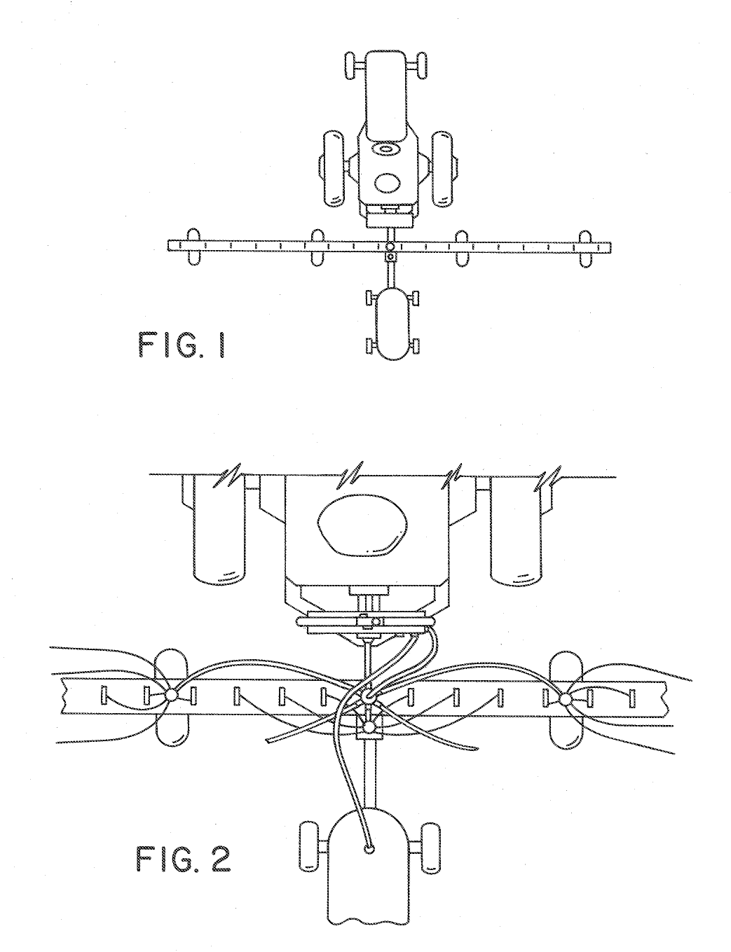

Referring initially to FIGS. 1 and 2, where like numerals refer to like and corresponding parts, an ammonia distribution system 10 includes a pre-cooler heat exchanger 12 mounted on a tool bar 14. Tractor 16 pulls the tool bar 14 and the ammonia nurse tank 18 in conventional fashion. A manual meter 17 receives ammonia from the tank 18 by way of pre-cooler heat exchanger 12, then metered ammonia flows to ammonia dividing manifold 20, is divided, and then the divided flows are then further divided in sub-manifolds 22 connected to knives 24 on tool bar 14. Knives 24 inject precisely-metered and accurately-divided streams of ammonia liquid and vapor into the soil as the tractor traverses an agricultural field.

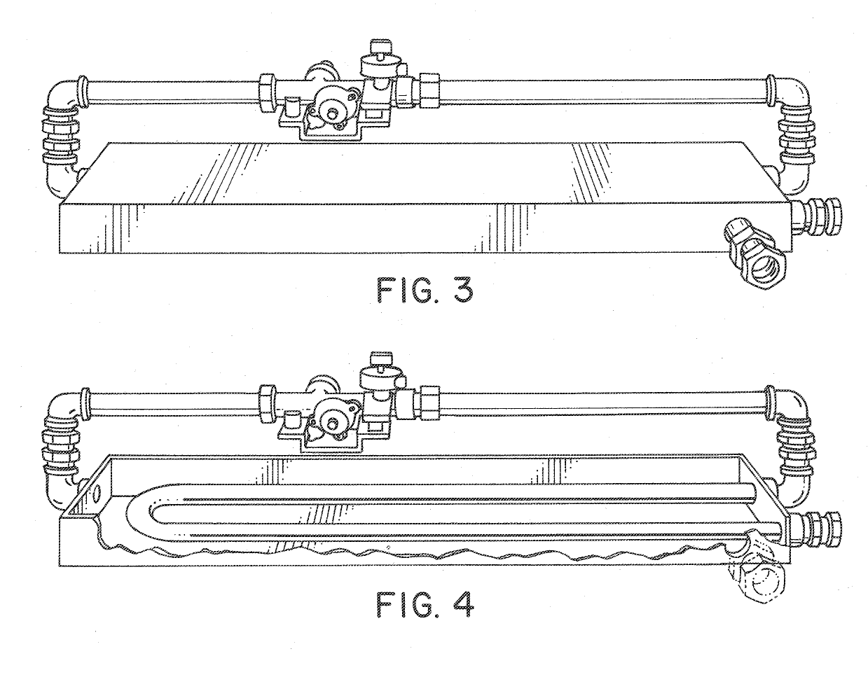

The present invention is primarily focused on pre-cooler heat exchanger 12, which is shown in detail in FIGS. 3 and 4, where like numerals refer to like and corresponding parts. Pre-cooler heat exchanger 12 has an inlet conduit 30 connected to the source of ammonia, i.e., nurse tank 18, by way of hose 32. The inlet conduit 30 is located downstream of the source of ammonia, nurse tank 18.

Reservoir 34 is located downstream of the inlet conduit 30 to receive a mixed stream of ammonia liquid and vapor from the source of ammonia by way of the inlet conduit 30. In one embodiment of the invention, reservoir 34 is in the shape of an elongate rectangular prism, with first and second ends 36,38 and with a longest dimension being parallel to the tool bar 14, as best shown in FIG. 2. The inlet conduit 30 is located at the first end 36 of the reservoir 34, while an outlet conduit 40 is located at the second end 38 of the reservoir 34 opposite the inlet conduit 30 to expel a liquid stream of ammonia without vapor, as a result of cooling.

A manual meter inlet conduit 42 is attached to the reservoir outlet conduit 40 and extends to an inlet 44 of the manual meter 17. A manual meter outlet conduit 46 is attached to an outlet 48 of the manual meter 17 and extends to a cooling tube inlet 50 located at the first end 36 of the reservoir 34.

In one embodiment of the invention, the manual meter inlet conduit 42, manual meter 17, and manual meter outlet conduit 46 are located vertically above the reservoir 34, as shown in FIGS. 3 and 4.

A cooling tube 52 is located within the reservoir 34 to receive the entire flow of liquid ammonia from the meter and cool the contents of the reservoir. The ammonia downstream of the meter in the cooling tube will have a lower temperature than the ammonia in the reservoir because of the pressure drop across the meter. As shown in FIG. 4, the cooling tube 52 is an elongate U-shaped tubular body extending substantially the entire length of the reservoir 34 from the cooling tube inlet 50 to a cooling tube outlet 54 located at the first end 35 of the reservoir 34 adjacent the cooling tube inlet 50. Cooling tube outlet 54 is being connected to an ammonia dividing manifold.

In operation, the simple heat exchanger of the present invention will refrigerate the ammonia in the reservoir about 2-3 degrees F. to bring all of the flow back to liquid, which allows an increase in application rate of about 30%. In one example of the invention, a reservoir about 3 feet long has about 6 feet of tubing inside bent into a U-shape as shown in the FIGURES. The tubing is 1.5 inch OD stainless steel tubing with a 0.060 inch wall.

While the advantages of the invention will best be realized in a system having a manually-operated meter, it is also likely that there is some arrangement of system elements possible where benefit would be gained with a more modern electronic meter. “Meter” unless otherwise specified means a meter of either type.

It will be understood that each of the elements described above, or two or more together, may also find a useful application in other types of constructions differing from the type described above.

While the invention has been illustrated and described as embodied in a particular ammonia application system, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

I claim:

1. An ammonia distribution system including a meter and a tool bar, the ammonia distribution system comprising:
a pre-cooler heat exchanger having a reservoir inlet conduit connected to a source of ammonia, the reservoir inlet conduit located downstream of the source of ammonia;
the pre-cooler heat exchanger having a reservoir located downstream of the reservoir inlet conduit to receive a mixed stream of ammonia liquid and vapor from the source of ammonia by way of the reservoir inlet conduit;
a reservoir outlet conduit to expel a liquid stream of ammonia without vapor;
a meter inlet conduit attached to the reservoir outlet conduit and extending to an inlet of the meter;
a meter outlet conduit attached to an outlet of the meter and extending to a cooling tube inlet conduit located at the reservoir;
a cooling tube attached to the cooling tube inlet conduit and located within the reservoir to receive the entire flow of liquid ammonia from the meter and cool the contents of the reservoir; and
the cooling tube being connected to a cooling tube outlet conduit, and the cooling tube outlet conduit being connected to an ammonia dividing manifold.

2. The ammonia distribution system of claim 1 with the reservoir being in the shape of an elongate rectangular prism.

3. The ammonia distribution system of claim 1, with the reservoir having first and second ends and with a longest dimension being parallel to the tool bar.

4. The ammonia distribution system of claim 2, with the reservoir having first and second ends and with a longest dimension being parallel to the tool bar.

5. The ammonia distribution system of claim 1, with the reservoir having first and second ends, the reservoir inlet conduit being located at the first end of the reservoir, and the reservoir outlet conduit located at the second end of the reservoir opposite the reservoir inlet conduit.

6. The ammonia distribution system of claim 5, with the meter inlet conduit, meter, and meter outlet conduit being located vertically above the reservoir.

5. The ammonia distribution system of claim 5, with the cooling tube being an elongate U-shaped tubular body extending substantially the entire length of the reservoir from the cooling tube inlet conduit located at the first end of the reservoir to the cooling tube outlet conduit located at the first end of the reservoir adjacent the cooling tube inlet conduit.

6. The ammonia distribution system of claim 1 with the meter being a manually-operated meter.

7. An ammonia distribution system including a meter and a tool bar, the ammonia distribution system comprising:
a pre-cooler heat exchanger having a reservoir inlet conduit connected to a source of ammonia, the reservoir inlet conduit located downstream of the source of ammonia;
the pre-cooler heat exchanger having a reservoir located downstream of the reservoir inlet conduit to receive a mixed stream of ammonia liquid and vapor from the source of ammonia by way of the reservoir inlet conduit;
the reservoir being in the shape of an elongate rectangular prism, with first and second ends and with a longest dimension being parallel to the tool bar;
the reservoir inlet conduit being located at the first end of the reservoir;
a reservoir outlet conduit located at the second end of the reservoir opposite the reservoir inlet conduit to expel a liquid stream of ammonia without vapor;
a meter inlet conduit attached to the reservoir outlet conduit and extending to an inlet of the meter;
a meter outlet conduit attached to an outlet of the meter and extending to a cooling tube inlet located at the first end of the reservoir;
the meter inlet conduit, meter, and meter outlet conduit being located vertically above the reservoir;
a cooling tube located within the reservoir to receive the entire flow of liquid ammonia from the meter and cool the contents of the reservoir, the cooling tube being an elongate U-shaped tubular body extending substantially the entire length of the reservoir from the cooling tube inlet conduit to a cooling tube outlet conduit located at the first end of the reservoir adjacent the cooling tube inlet conduit;
the cooling tube outlet conduit being connected to an ammonia dividing manifold; and
with the meter being a manually-operated meter.
